(19) United States
(12) Patent Application Publication
(10) Pub. No.: US 2016/0078516 A1
(43) Pub. Date: Mar. 17, 2016

(54) WASUL TRANSPORT APPLICATION

(71) Applicant: Umm Al-Qura University, Makkah (SA)

(72) Inventors: Mohammed Abdulaziz ALNUWAYSIR, Al Madinah (SA); Amal Nasser Abdullah Alshehri, Makkah (SA)

(73) Assignee: Umm Al-Qura University, Makkah (SA)

(21) Appl. No.: 14/632,777

(22) Filed: Feb. 26, 2015

Related U.S. Application Data
(60) Provisional application No. 62/051,748, filed on Sep. 17, 2014.

(51) Int. Cl. G06Q 30/06; G06F 17/30; G06F 3/0484; G06F 3/0482

(52) U.S. Cl. CPC G06Q 30/0625; G06Q 30/0641; G06F 3/0482; G06F 17/30554; G06F 3/04847

(57) ABSTRACT

A system for peer-to-peer (P2P) transport accommodation including an application server configured to communicate with at least two user mobile location based service applications, the application server configured to provide user access for administration, registration, edit and settings, view and retrieval of transactional records, a user mobile land based service application that runs on a user mobile device and configured to communicate with the application serve and enable the at least two users to communicate directly with one another, wherein the user mobile land based service application is further configured to register a user and allow a user to login in a service provider mode, service requester mode or both, service provider and service requester modes.

### CROSS-REFERENCE TO RELATED APPLICATIONS

This application claims priority to provisional application Ser. No. 62/051,748, filed Sep. 17, 2014, the entire contents of which are herein incorporated by reference.

### BACKGROUND

The description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The majority of ground transportation service providers, from taxi to limousine to tow truck companies, operate using the same dispatching methodology and technology they have used for decades. A primary central terminal is used and controlled by a service provider, such as a taxi company, to collect orders/requests and dispatch taxis. This method can be error prone, inefficient and inconvenient. Using such traditional systems, scheduling a trip or a pick up can be time consuming and frustrating for people. Unexpected delays encountered by transportation service providers in getting to passengers can lead to unhappy customers that may be lost.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

In one embodiment, there is described a system for peer-to-peer (P2P) transport accommodation that includes circuitry configured to detect a user application executing on a mobile computing device of a user to communicate with another user over a network; detect the user's login status as a service provider, service requester or both service provider and service requester and provide an interactive search menu based on the user login status; determine a location of a set of available service providers and service requesters, the location of each available service provider and service requester being based on data determined by a user application executing on a corresponding mobile computing device associated with that user; receive a request from a first user application executing on a mobile computing device of a first user, the request including at least one parameter solicited by the first user; and in response to receiving the request from the first user, display an available user that has advertised a capacity of performing the at least one parameter solicited by the first user.

The system is further configured to allow the user to log in as a service requester, such that upon detecting the user's login status as a service requester, the circuitry is further configured to provide an interactive search menu with criteria aimed at soliciting services from at least one user logged in as a service provider. Furthermore, the interactive menu allows the service requester to set at least one service request parameter related to a requested transport service. Additionally, wherein the at least one service request parameter includes at least one of a geographic location parameter, a pick up time parameter, a drop off time parameter, a service provider rating parameter, a service provider information parameter, a service vehicle information parameter, a traveled route parameter, a package size parameter, or an estimated cost parameter. Wherein in response to receiving the request with at least one set criterion from the service requester, the circuitry is further configured to display at least one available user that has logged in as a service provider; and the circuitry is further configured to display the service request to the service provider. Wherein the displayed service request further includes a presenting the service provider an option to accept, reject or counter offer the service request and in response to receiving a response from the service provider, the circuitry is further configured to display the service provider response to the service requester.

The system also allows the user to log in as a service provider. Wherein upon detecting the user's login status as a service provider, the circuitry is further configured to provide an interactive search menu with criteria aimed at advertising the services of the service provider and soliciting requests for service from at least one user logged in as a service requester. Wherein the user logs in as both, a service requester and as a service provider. Wherein the circuitry is further configured to schedule a task on the user's mobile application executing on the mobile computing device of the user such the task is automatically scheduled on the user's mobile application when the user agrees to the terms of service between the user and at least one other user. Wherein the circuitry is further configured to establish a P2P interactive window between in response to receiving the request from the first user and displaying the request to an available user.

### BRIEF DESCRIPTION OF THE DRAWINGS

The disclosure will be better understood from reading the description which follows and from examining the accompanying figures. These are provided solely as non-limiting examples of embodiments. In the drawings:

FIG. 1 describes one illustration of Wasul Transport Application integrated within a mobile device according to an embodiment;

FIG. 2 illustrates a set of diverse transport means available for Wasul Transport Application according to an embodiment;

FIG. 3 illustrates the diverse transportation options available within a vicinity of a service requesting user of the Wasul Transport Application according to an embodiment;

FIG. 4 illustrates the diverse users requesting services within a vicinity of a service providing user of the Wasul Transport Application according to another embodiment;

FIG. 5 illustrates a high and low level architecture of a system for coordinating transport services in accordance with an embodiment;

FIG. 6 illustrates a flow chart of a general method of coordinating transport services using the system of FIG. 5 in accordance with an embodiment;

FIG. 7 illustrates a simplified service requester-provider transaction flowchart employed using the system of FIG. 5 in accordance with one embodiment; and

FIG. 8 illustrates a sample selection menu for a requester to advertise his/her requirements to logged-in service providers according to one embodiment.

### DETAILED DESCRIPTION

The description provided here is intended to enable any person skilled in the art to understand, make and use this invention. Various modifications to the disclosed embodiments will be readily apparent to those skilled in the art, and the general principals defined herein may be applied to these modified embodiments and applications without departing from the scope of this invention. In each of the embodiments, the various actions could be performed by program instruction running on one or more processors, by specialized circuitry or by a combination of both. Moreover, the invention can additionally be considered to be embodied, entirely or partially, within any form of computer readable carrier containing instructions that will cause the executing device to carry out the technique disclosed herein. The present invention is thus, not intended to be limited to the disclosed embodiments, rather it is be accorded the widest scope consistent with the principles and features disclosed herein.

Details of functions and configurations well known to a person skilled in this art are omitted to make the description of the present invention clear. The same drawing reference numerals will be understood to refer to the same elements throughout the drawings.

Although the description and discussion were in reference to certain exemplary embodiments of the present disclosure, numerous additions, modifications and variations will be readily apparent to those skilled in the art. The scope of the invention is given by the following claims, rather than the preceding description, and all additions, modifications, variations and equivalents that fall within the range of the stated claims are intended to be embraced therein.

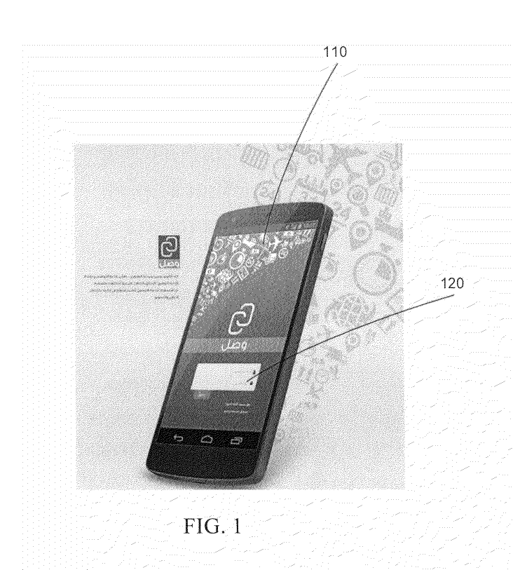

FIG. 1 describes one illustration of Wasul Transport Application 110 (WTA) integrated within a mobile device according to an embodiment. WTA 110 may be integrated on any mobile device application, downloadable by any user with access to the internet or data network and is available on any and all peer-to-peer (P2P) platforms, including but not limited, for example, Google Android systems and Apple iOS platforms. WTA is further configured to be used on any computing device. WTA links a delivery service requester with a deliver service provider. A delivery service requester may be any type of delivery service requester such as a person requesting a delivery of the person him/herself or delivery of a product or a commodity. The delivery service provider may be any person specialized or not specialized in the craft of delivery. For example, a person who has downloaded WTA can log in and view who is requesting services and attempt to engage that service requester if the service provider is willing or able to perform the delivery service within given parameters.

WTA has many advantages as a mobile application. Such advantages include scheduling tasks for service providers and delivery orders for service requesters; facilitating the search process for both, service providers and service requesters; and providing an interactive environment where service providers and requesters are able to communicate directly to perform negotiations and discuss further details related to delivery request. WTA may also serve as an additional source of income for its users such that anyone of WTA users can sign in as a service provider and perform services if engaged by service requesters.

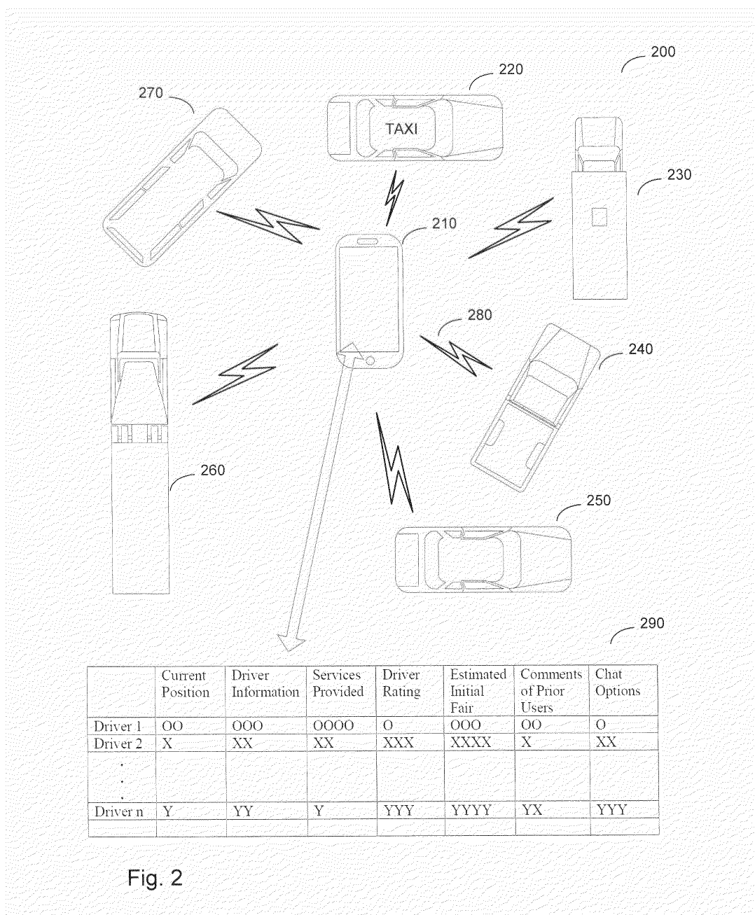

FIG. 2 illustrates a set of diverse transport means 200 available for Wasul Transport Application according to an embodiment. WTA offers, among many services, two distinct services, the transport of commodities or people from one location to another. In one example, transport means 200 includes a mobile device 210 that has WTA already integrated within the mobile device 210 operating system via installation or download. Mobile device 210 enables the user, such as a service requester, to view the types of vehicles and services providers available within the system and able to provide the service requested by the service requester. For example, the service requester may be able to see a listing of available service providers and vehicles, such as a taxi 220, a small shipping truck 230, a truck 240, a private automobile 250, a semi-transport truck 260, a van 270, or any other type of vehicle available for transport of people or commodities. After performing a search request, a service requester may be able to view the available service providers via table 290.

Table 290 is used for illustrative purposes and is not meant to be limited to the categories shown. For example, the service requester may be able to view a listing of available drivers according to the driver's current position, the driver information, services to be provided, driver rating, estimated initial fair, comments of prior users and chatting options. Driver information may include, but not limited to, the vehicle type, driver history, background, prior routes, prior ratings, and prior services performed by the selected driver. Services provided may include services advertised by the driver as currently available. For example, Driver 1 may have advertised that Driver 1 is able to carry a commodity of up to a certain size and weight within a specified zone, radius or a given route. The driver rating may be the rating earned by the driver from prior services provided. This can include ratings by other drivers or ratings from users who have previously used the driver. Driver rating may also include additional details such as time of the rating, rating trends, etc.

In yet another embodiment the estimated initial fare is based on an initial calculation given the specific parameters previously set by the service provider. For example, driver 1 may have included a delivery along a specific rout or within a specific zone or radius for an estimated price of “OOO”. This enables the service requester to perform an initial filtration based on estimated prices and determine which driver might be more suitable for the service requester. The table may further illustrate comments of prior users. Such comments include the ability for a service requester who has previously used this specific service provider, in this case, driver 1, to discuss the performance of the driver, the timeliness, pricing, etc. Upon searching for a service provider, or in another case, service requester, as will be discussed further below, the parties may initiate a chat option. The chat option may be initiated only after a driver is selected or viewed to reduce cluster of information and maintain service requester privacy and information load. For example, when a service requester views a list of available service providers, a service requester only may request to chat with the provider. The chat option may be via touch screen text messages or may also be via small increment speech messages such as walky-talky messages.

In yet another embodiment, the information displayed in the table is accessible via touch screen or any other means available on a mobile device. In one such example, a user interface, such as the touchscreen on a mobile device, enables a user viewing the table to tap or touch each table heading and an additional menu may be presented. For example, comments of prior user's cell may only include a limited amount of information. Tapping on the cell opens another window that allows a service requester to read comments made by prior users.

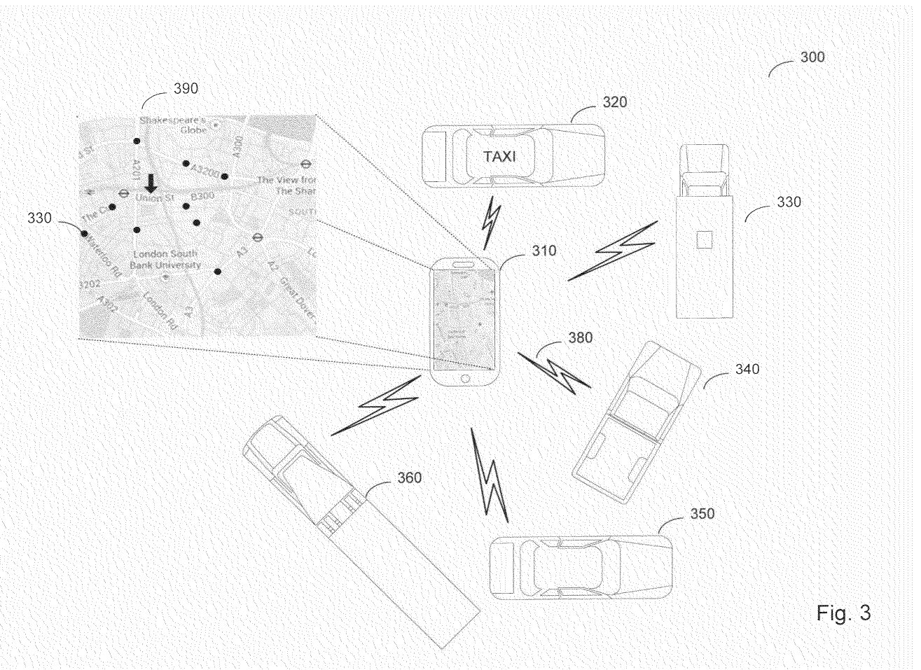

FIG. 3 illustrates the diverse transport means 300 available within a vicinity of a service requesting user of the WTA according to an embodiment. Means 300 include a mobile device 310 with WTA installed on the device mobile device 310. WTA can be configured to display the available service providers via table (as shown in FIG. 2) or via a map of the geographic vicinity of the service requester. A map, such as map 390 can be configured to illustrate where the mobile device 310 and associated user are located with respect to other available service providers in the geographic vicinity. Geographic vicinity can be set by the service requester. For example, the service requester can request a radius or zone, such as 500 meters or 1 kilo-meter, or more. Transport means 300 may include a wide variety of transportation vehicles that are equipped to transport persons or commodities. Such transportation vehicles may include, but are not limited to, taxi 320, moving truck 330, personal truck 340, private car 350 and/or semi-truck 360. A transportation vehicle, such as truck 340 may include a module or a mobile device that has WTA installed on it and this allows WTA on the mobile device within truck 340 to communicate with mobile device 310 via link 380. Link 380 may be any type of wireless communications, such as WiFi, internet, or cellular and data network.

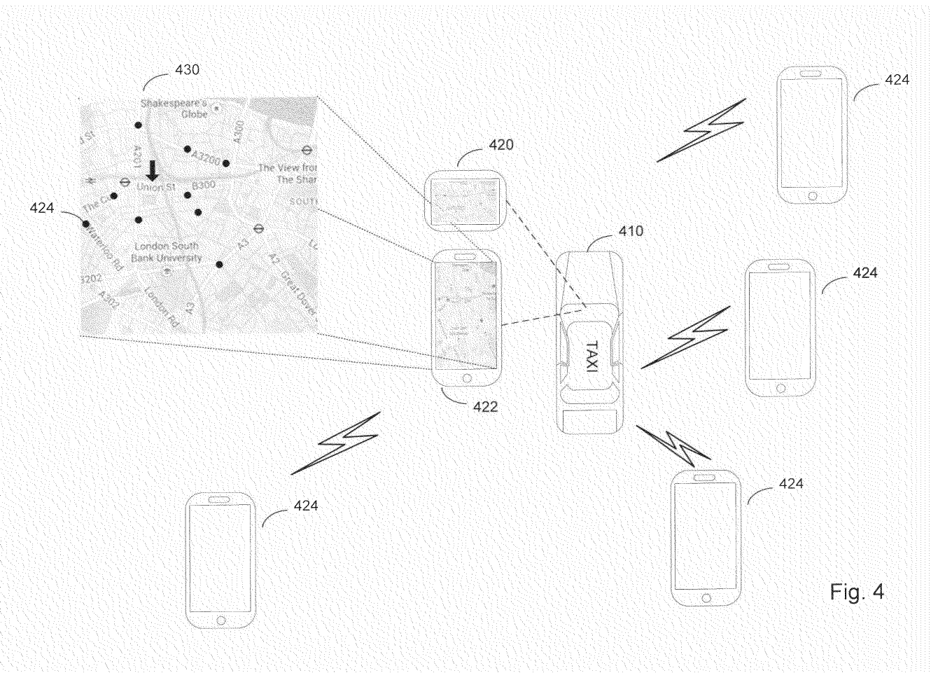

FIG. 4 illustrates the diverse users requesting services within a vicinity of a service providing user of the WTA according to another embodiment. Wherein FIG. 3 illustrated a service requester searching for potential service providers, FIG. 4 illustrates a service provider searching for potential service requesters. For example, a service provider 410 may login to WTA as a service provider and request a search for all service requesters within a given parameter. Upon a completion of a search, results may show service requesters such as service requester 424 dispersed throughout a given zone or geographic location. Service provider 410 may be a taxi driver in this example, however, service provider 410 may be any other person or entity who has downloaded or installed WTA on their mobile device and is able to login as a service provider. Service provider 410 may login to WTA via a mobile device, such as mobile device 422 or alternatively, may login to WTA via an on board module, such as a networkable navigation system 420. Either one of mobile device 422 or on networkable navigation system 420 may be configured to display a table such as FIG. 2 or a map such as map 430 illustrating all available service requesters 424.

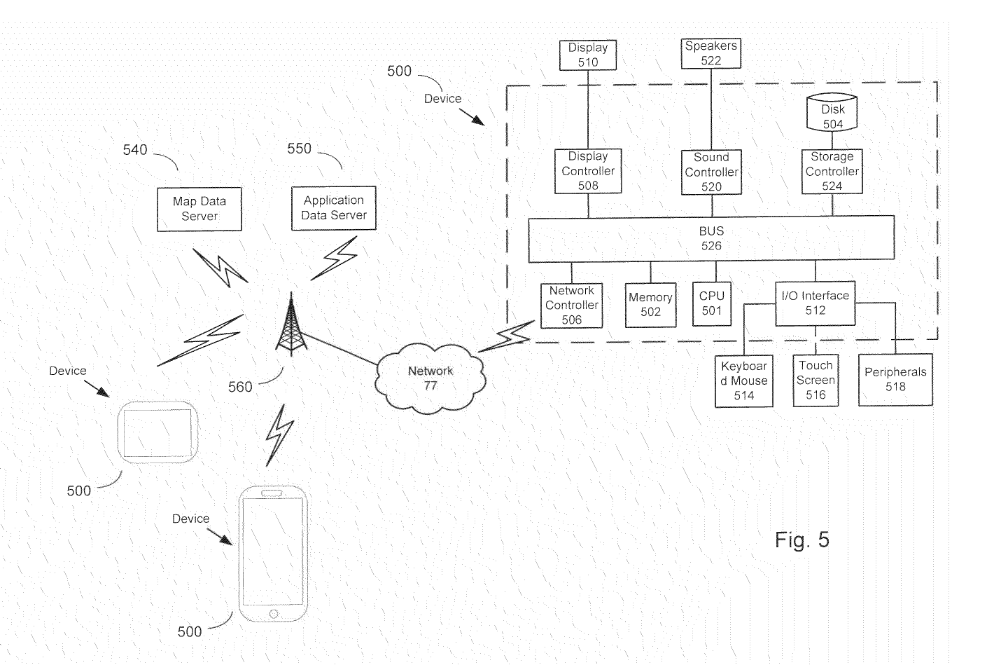

FIG. 5 illustrates a high and low level architecture of a system for coordinating transport services in accordance with an embodiment. A hardware description of a device, such as a mobile device, according to exemplary embodiments illustrated in FIGS. 1-4 is described with reference to FIG. 5. In FIG. 5, device 500 may be a mobile device or a networkable Global Positioning System (GPS) device or both. Device 500 includes a CPU 501 which performs the processes described above. The WTA application may be may be stored in memory 502. The WTA may also be stored on a storage medium disk 504 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device communicates, such as a server or computer.

Further, the claimed advancements may be provided as a utility application, background daemon, or component of an operating system, or combination thereof, executing in conjunction with CPU 501 and an operating system such as Microsoft Windows 7, UNIX, Solaris, LINUX, Apple MAC-OS and other systems known to those skilled in the art.

CPU 501 may be a Xenon or Core processor from Intel of America or an Opteron processor from AMD of America, or may be other processor types that would be recognized by one of ordinary skill in the art. Alternatively, the CPU 501 may be implemented on an FPGA, ASIC, PLD or using discrete logic circuits, as one of ordinary skill in the art would recognize. Further, CPU 501 may be implemented as multiple processors cooperatively working in parallel to perform the instructions of the inventive processes described above.

Device 500 also includes a network controller 506, such as an Intel Ethernet PRO network interface card from Intel Corporation of America, for interfacing with network 77. As can be appreciated, the network 77 can be a public network, such as the Internet, or a private network such as an LAN or WAN network, or any combination thereof and can also include PSTN or ISDN sub-networks. The network 77 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

Device 500 further includes a display controller 508, such as a NVIDIA GeForce GTX or Quadro graphics adaptor from NVIDIA Corporation of America for interfacing with display 510, such as a Hewlett Packard HPL2445w LCD monitor. A general purpose I/O interface 512 interfaces with a keyboard and/or mouse 514 as well as a touch screen panel 516 on or separate from display 510. General purpose I/O interface also connects to a variety of peripherals 518 including printers and scanners, such as an OfficeJet or DeskJet from Hewlett Packard.

A sound controller 520 is also provided in the device, such as Sound Blaster X-Fi Titanium from Creative, to interface with speakers/microphone 522 thereby providing sounds and/or music. This further enables the service provider and the service requester to interface and exchange audio messages such as walky-talky messages or even a phone conversation.

The general purpose storage controller 524 connects the storage medium disk 504 with communication bus 526, which may be an ISA, EISA, VESA, PCI, or similar, for interconnecting all of the components of the device. A description of the general features and functionality of the display 510, keyboard and/or mouse 514, as well as the display controller 508, storage controller 524, network controller 506, sound controller 520, and general purpose I/O interface 512 is omitted herein for brevity as these features are known.

Devices 500 may connect with each other via network 77 as discussed above or via wireless network 560. A map data server 540 and/or an application data server 550 may further be used to enhance the functionality of WTA. The map data server can be configured to store data about a map of an area covering from a current position of each of devices 500 logged in to WTA. Map data server 540 may be further configured to relay such position data to a service requester or service provider user as well as general geographic data such as speed restriction, traffic jams and the like.

Application Data Server may include typical module architecture of a Mobile location based service (LBS) application. The service requester or the service provider may use Wasul Transport Application (WTA) as a Mobile LBS application that runs on the user's smartphone. It consists of a user interface and various modules such as one for searching for available service providers and service requesters, entering trip information, a module for managing location and movement information, a client-server communications module, and a push notification handler etc.

The Application module (not shown) consists of a user interface and it communicates between the Application Server and its various modules such as Messaging module, Maps and routing module, location module, privacy module, content module and billing module.

The application module also communicates with the various functionality features such as SMS, MMS, LBS and Payment provided by the Mobile Operator through Gateway connectors services.

The module on the user mobile terminal such as the Messaging Module is for the instant messaging service, and the Location Module is a LBS-client component for the location information provisioning. The location information requests are signalled via specially encoded instant messages between the clients on the participating mobile devices. A GPS positioning device at the mobile terminal is used for sending the raw location coordinates (Longitude-Latitude-Altitude) to the requesting peer. Using this location information, a map or street address can be obtained from an external Map server of the positioned peer (e.g. Google Maps) via GPRS. The interface between LBS client and an application service provider uses standardized HTTP or SIP based communication.

In one embodiment, a positioning request between two mobile peers (service provider and service requester) may be carried out as follows: a mobile peer (service requester) registered with the location-based service can request the position of another fellow registered peer (service provider) from his Messaging Menu.

Depending on privacy settings of the service provider, (handled by the Privacy Module), a message pop-up will be displayed on the service provider's display showing service requester's request. If the service provider's setting is set to ‘accept allowed’ for User B, no message will appear in this case. If the request of service requester is granted by the service provider, GPS coordinates will be converted to a special Message format and transmitted to the service requester. Once the required position coordinates are received by service requester, a Map showing service provider's location (handled by Maps and Routing Module) can be received from the online map server.

Table I below is an example of registration method for a user.

TABLE I
Registration via Form

| Use Case | Registration via Form | |
|---|---|---|
| Name | | |
| Actor | service requestor - service provider | |
| Goal | Allow the user (service requestor/provider) to create | |
| | profile and then start using the application | |
| Brief | The user fills the form with needed information to create | |
| description | his/her profile in Wasul | |
| Pre- | none | |
| condition | | |
| Post- | none | |
| condition | | |
| Flow of | | |
| Activity | | |
| Example | 1- | The user will choose his role in the system by |
| Steps | | clicking on the suitable button (service provider |
| Followed | | OR service requestor) after the tutorial finishes |
| by an | 2- | The user will fill in the required information |
| Actor | | according to the displayed form |
| | 3- | The user should click registration button after |
| | | completing the form |
| | 4- | The user should correct the wrong or incomplete |
| | | information if the system notifies him/her |
| Example | 1- | The system will display the tutorial first, if |
| Steps | | necessary |
| by the | 2- | After the required button pressed- the suitable |
| System | | form will be displayed for the user |
| | 3- | The system will check inputs after the user click |
| | | the registration button |
| | 4- | If the entered information were wrong or |
| | | incomplete the system will notify the user |
| | 5- | -5the system will not accept the registration |
| | | unless the entered information are applicable |

| | |
|---|---|
| Related Use | none |
| cases | |
| Exception | If the user chooses to register using Twitter ™/Facebook ™ |
| conditions | accounts |

Alternatively, the user can follow a one-click registration method that enables communications between the service requester and the service provider. By doing so, the system allows the user to create a profile and then start using the application. This embodiment is further illustrated by Table II below.

TABLE II
One Click Registration

| Use Case | One-click registration | |
|---|---|---|
| Name | | |
| Actor | service requestor - service provider | |
| Goal | Allow the user (service requestor/provider) to create profile | |
| | and then start using the application | |
| Brief | The user use this choice to register in Wasul with | |
| description | (Twitter ™/Facebook ™) accounts instead of filling the | |
| | whole form | |
| Pre- | The user must have account in Facebook or Twitter | |
| condition | | |
| Post- | none | |
| condition | | |
| Flow of | | |
| Activity | | |
| for Actor | 1- | The user must enter his/her (Twitter or Facebook) |
| | | username and password |
| for System | 1- | The system will display the tutorial first |
| | 2- | After the required button pressed- the suitable form |
| | | will be displayed for the user |
| | 3- | The system will check inputs after the user click the |
| | | registration button |
| | 4- | If the entered information were wrong or incomplete |
| | | the system will notify the user |
| | 5- | The system will not accept the registration unless the |
| | | entered information are applicable |

| | |
|---|---|
| Related Use | none |
| cases | |
| Exception | If the user chooses to register via Form- |
| conditions | If the user's account is not verified- |

Alternatively, the service requester can calculate the distance to the remote peer service provider using the location information from his own GPS device. Using this principle, it would be possible to find nearby service providers, triggering an instant message if registered service provider comes into range. This could be realized by performing periodic location requests to registered peers.

The location request between two peers is only possible if both peers are online. Hence it is necessary to know the presence status (online/offline) of the peer before sending any location requests. The Billing Module handles the payment services such as service charge.

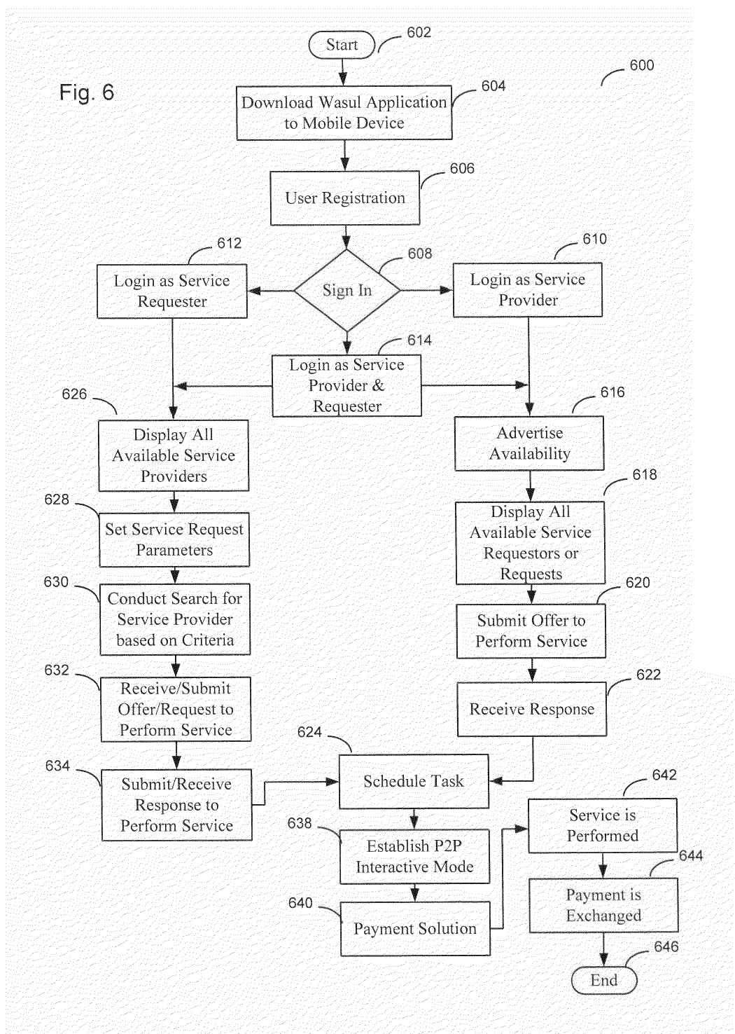

FIG. 6 illustrates a flow chart of a general method of coordinating transport services 600 using the system of FIG. 5 in accordance with an embodiment. Method 600 includes a starting point to start the application 602. If the smart device or mobile device does not have the WTA downloaded, a user may download 604 WTA on to the mobile device. After downloading WTA, a user is prompted to register 606 into the WTA in order to be able to logged in and use the features of the application. Unique to this application is the ability for a user to register different profiles within the application to allow the user to advertise their need according to different situations. For example, a user need not only be a service provider or a service requester. As such, once a user registers at least one profile, the user may select to sign in 608 as a service requester 612, a service provider 610 or as both, a service requester and a service provider.

This feature enables a user to have the flexibility in performing services when time allows and requesting services on need basis. It also allows a user to monitor a service being requested while engaging in a service currently being provided. For example, a user may be planning a trip from one town to another, e.g. New York City to Chicago, the user may login as a service provider and advertise his services to transport a commodity along with his belongings from New York City to Chicago. This service may enable the user to earn extra income or cash to cover certain expenses. Alternatively, the user may login as a service requester while looking for potential service providers that can transport a type of commodity. Alternatively, the user may login as both a service requester and service provider to enable both of the modes' capabilities and features, tracking of a service being provided to the user and tracking of a service being provided by another service provider to the user. Logging in as a service provider and a service requester enables the user to obtain all the functional capabilities of both profiles.

In one embodiment, a user may login as a service provider 610. As a service provider, the user can advertise his/her availability and service 616, display all available 618 service requesters that may fit his search criteria, or display all service requesters that have engaged his services. For example, a service provider can advertise that he is a service provider, available to transport a passenger or a commodity. In cases of passengers, the availability does not need to be specified to a region or a zone, but simple blanket availability. Alternatively, it can be shown that the service provider is available, but can run special rates within a specific zone, such as an airport or a downtown area. For example, service provider may advertise availability and also have a small disclaimer or small advertisement stating that “rides within this zone” or “lifts to the airport are discounted at 10% rate”. The advertisement may further include a time limitation such as “lifts to the airport are discounted at 10% between 6 μm and 10 μm today.”

When the service provider displays 618 all service requests or available service providers 618, the service provider has the option to select service requester and submit an offer 620 to perform the service being requested. For example, if within the displayed list, the service provider sees at least one service requester advertising a request for services, such as a lift to a location (taxi service) or a transport of a commodity (deliver service) the service provider may submit an offer 620 to perform the service. At this point, the service requester may accept or reject the offer and the service provider receives a response 622 from the service requester. In another embodiment, the service requester may also issue a counteroffer with different parameters, such as cost rate, distance, size, weight, etc., of the shipment to be transported. If there is an agreement, the task is then scheduled 624. For example, a service provider can advertise and/or submit an offer 620 to perform a service. A service requester searching for the specific service provider, or searching for a service within the region may see the offer that has been submitted by the service provider. Alternatively, the service provider may directly submit an offer to the service requester. In all cases, the service requester, upon receiving an offer to perform the service has options to accept, reject or counter the offer. An offer from either entity will, as mentioned before, include several service parameters, including, for example, the rate, package size or object to be transported, including potentially a person, weight of the object to be transported, time requirements, route requirements, delivery speed, etc.

Upon receiving the offer, the service requester can counter offer by filling in different terms than those offered by the service provider. A counter offer may be initiated in several ways. One such way includes an option on the display of WTA for the user, in this case a service requester to tap an “accept” or “reject” or “counter offer” option. Upon acceptance, WTA may send a notification to the service provider of the acceptance and a scheduling task to schedule the event on the service provider's calendar. The same may take place for the service requester. Alternatively, if the service requester selects the reject option, then the service requester can have the option to ask the service provider to submit another offer or prevent the service provider from submitting any additional offers. If the option of submitting another offer is selected by the service requester, then a notification message is displayed on the service provider's device indicating that the offer has been rejected and that the service provider can submit another offer. Or alternatively, the service provider can be notified that the offer to perform the service is rejected and no additional offers are solicited at the present time.

In an alternative embodiment, the service requester can select to counter offer the service provider's offer. To do so, the service requester can tap the counter offer button displayed by WTA and allow the service requester to modify the terms of the service being offered before submitting back to the service provider. The modification of the terms can include changing terms, and adding and subtracting terms. Changing terms includes changing any type of term parameter. For example, rate can be modified, from $20 to $15. Alternatively the service requester can add additional terms. For example, if a specific route is not included, a service requester may include a specific route to be utilized for delivery, or specific accommodations needed by the service requester. The service requester may alternatively remove parameters that are deemed unnecessary in order to simplify the order. For example, if the service provider has advertised a specific route, the service requester may counter offer by removing the route in order to simplify the order or reduce the rate, etc.

In another embodiment, if the user logs in as a service requester, WTA will display all available service providers 626 to the service requester. A service provider is displayed as available if the service provider is logged in to WTA and advertised his/her availability. A service requester may set 628 the service request parameters. For example, the service requester may set parameters related to time, date, distance, location, zone, car size, pick-up and drop-off location, driver credentials, driver rating, etc. WTA would then conduct 630 a search for service providers based on the criteria set by the service requester and display the results. The results may be displayed in a tabled list format or may be displayed on a map format giving the user great location context. The service requester may receive 632 an offer to perform a service from at least one service provider. The service requester may alternatively send a service request to an advertising service provider. A service request is received by the service provider in any one of multiple formats, including a standard format that houses minimum criteria searched by the service requester. The service requester may then submit or receive a response to perform the service 634 and proceed to schedule the task 624.

WTA can also serve as a unique task scheduler. For example, for service providers, WTA allows a service provider to schedule all associated tasks for a given period of time. In a further example, if the service provider is a taxi driver, WTA can allow the taxi driver to address immediate pickups, but it can further allow the taxi driver to schedule future pickups, for that specific day or for a week or further time in advance. This allows the taxi driver to schedule his routes, track his movements, and run a more efficient profitable business. Alternatively, if the service provider is a shipping person, the service provider can schedule shipping tasks according to his rout such that he can schedule tasks far in advance to secure income and arrange his tasks in more timely and cost efficient manners. For example, if the service provider knows that he has a pick up from Zone A on Tuesday, and then he may be more inclined to search for other pickups from Zone A on Tuesday.

As mentioned before, certain settings allow the peers to communicate directly via text messaging or alternative means. WTA can be configured to allow text messaging under strict privacy standards, such as those only authorized by the user. Alternatively, peers may be able to establish a P2P interactive mode after agreeing on the task 638 or at earlier stages of communications. For example, if a service provider has sent a service requester an offer, the service requester may have the ability to establish a P2P interactive mode with that specific service provider. Alternatively, a service provider may not randomly establish a P2P interactive mode with a service requester the service provider has not yet engaged. Alternatively also, a P2P interactive mode may be established at any time in the procedure provided that the user's privacy settings allow such communication.

At a minimum, a service provider and a service requester can establish a P2P interactive mode 638 upon the scheduling of the task to enable communication between the parties to further advance the transaction. For example, the P2P interactive mode may enable a service requester for additional terms, or privileges, or vice versa. In another example, the P2P interactive mode may allow the parties to chat and negotiate better terms, or make additional recommendations, or take into consideration additional notes, or may even be used to track a shipment via text messaging.

After establishing a P2P interactive mode 638, which again, could be instituted at other phases of the interaction, a payment solution is instituted 640, and the service is performed 642. As mentioned above, the service performed could be a wide variety of services relating to the transport of people and/or commodities. Such transport may include transport of people, taxiing or lifting people from one location to another in exchange for a fee. Alternatively, the transport service could be for commodities, as such, moving commodities from one geographic location to another, including delivery systems such as food delivery system. For example, a food delivery system may increase its potential delivery network by allowing users who login as service providers and who fit a certain criteria to deliver products to a given location. In one such example, a user whose neighbourhood has multiple food delivery requirements on daily basis, such as fast foods or pizza deliveries, may advertise himself to be available should a service requester have a delivery in the area where the user lives. For example, a user could, on his way home, show himself to be available for deliver, and a service provider, such as a pizza shop, can engage his services via WTA to deliver pizza to orders in his neighbourhood if the times coincide. After the service is performed 642, a payment is exchanged 644 and the WTA transaction is terminated 646.

WTA is further configured to track prior transactions for record keeping for the user. This enables the user to track expenditure but also allows the user to potentially approach another user previously used and solicit future services.

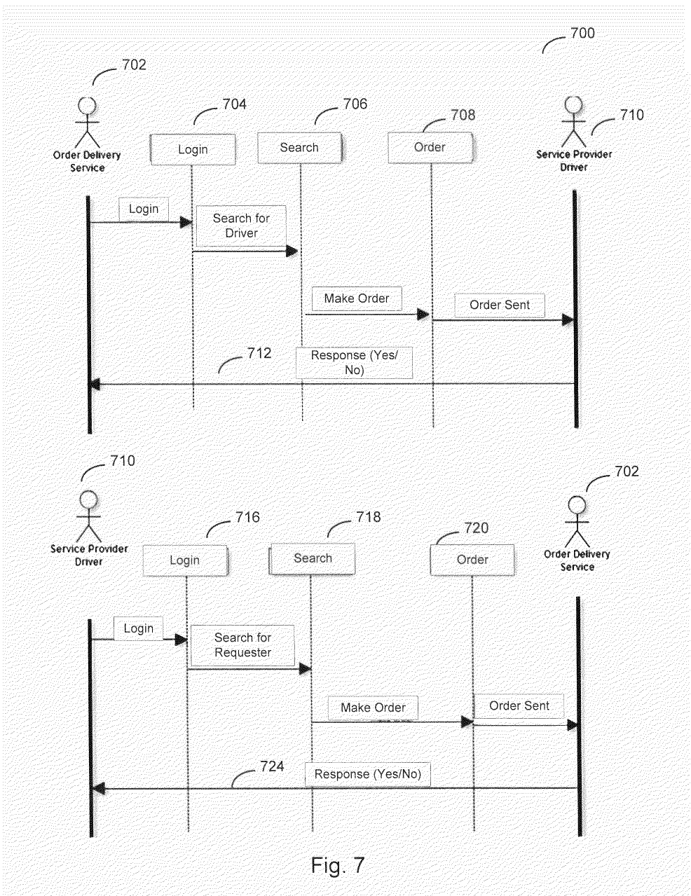

FIG. 7 illustrates a simplified service requester-provider transaction flowchart 700 employed using the system of FIG. 5 in accordance with one embodiment. Transaction 700 includes a user 702 who can login to WTA as a service provider, service requester or both. In this example, user 702 logs into WTA as a service requester and conducts a search 706 for a driver. After finding a suitable driver, service requester 702 then makes an order 708 and sends the order to service provider driver 710. Service provider driver 710 then sends 712 a response accepting or not accepting the order back to service requester 702.

From the Service provider driver 710 standpoint, service provider 710 logs 716 into WTA as a service provider and has the option to search 718 for a requester given specific criteria or perform a general search for requesters. After finding a service requester the service provider driver would like to work with, service provider driver 710 then sends an order request 720 to the service requester soliciting the service requester 702 to order a delivery service. Upon making a decision, service requester 702 then sends a response 724 back to the service provider driver 710 indicating acceptance or rejection of the solicitation.

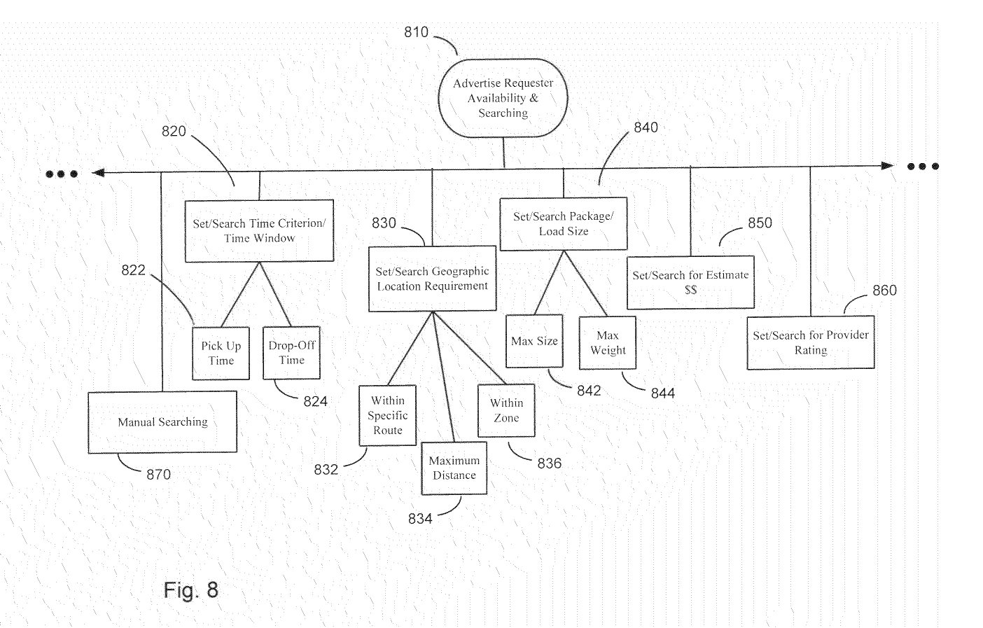

FIG. 8 illustrates a sample selection menu for a service requester to advertise availability and search for services. When logged in as a service requester, a user may advertise his availability as a service requester and set searching criteria 810. The service requester may set service criteria based on a multitude of factors, including but not limited to, time criterion and time window 820, geographic location requirement 830, package and load size 840 and estimated price 850, search for provider by provider rating 860 or perform manual searching 870.

In one embodiment, a service requester can modify a search by selecting a requested pick up time 822 or a specified drop off time 824. For example, if the service requester needs to be picked up on a specific date and at a specific time, the service provider can set those two criteria and WTA will show available service providers to engage. In one example, a service requester may need to schedule a pick up time for an airport transport at a specific time the following week; a service provider can set such criteria and look for available service providers. WTA will perform a search based on all users that are logged in and logged in as service providers at the time of the search. Furthermore, WTA will perform the search base on schedule entries of each a database of service provider schedules for openings and relay available service providers with availabilities to the service requester.

Alternatively, while not shown here, but a service requester can “set” his/her task requirements and await a solicitation from service providers. For example, a service provider can set service parameters such as pick up time and/or drop off times and wait for service providers able to perform the required task to submit their services. Furthermore, a service requester may set geographic location requirements, such as requesting drivers who travel within specific zones 832, or specific routes 836 such as downtown-airport routes, etc. A service requester may further request within a maximum distance 834. Furthermore, a service requester may set size parameters such as minimum and maximum size 842 and minimum and maximum weight 844. This enables a more compatible search result and more efficient use of resources. For example, a truck driver as a service provider may not be needed for a given size of passengers, or alternatively, a car may not be necessary for a given size of load to be delivered.

Table III below illustrates a search scenario for searching by location or route/path criteria set by the service requester:

TABLE III
Search by location or Route/Path

| Use Case | Search - by Location or Route/Path | |
|---|---|---|
| Name | | |
| Actor | service requestor | |
| Goal | Allow the user (service requestor) to search for a | |
| | provider depends on his location | |
| Brief | The user can choose a driver near to him | |
| description | | |
| Pre- | Location service must be enabled - | |
| condition | A map will be presented after a registration/login - | |
| | process that shows users near the current location with | |
| | symbols differentiate user types | |
| Post- | The result of the user query will take effect on the map | |
| condition | displayed to the user | |
| Flow of | | |
| Activity | | |
| for Actor | 1- | The user must sign in first so that users near his |
| | | current location will be displayed. |
| | 2- | If the location service is disabled the user must |
| | | react to the notification the system shows |
| | 3- | If the user doesn't react to the notification |
| | | results cannot be displayed probably. |
| for System | 1- | The system should check if location service is |
| | | enabled |
| | 2- | If it isn't enabled then it should notify the user |
| | | to enable it and allow quick access to this service |

| | |
|---|---|
| Related Use | none |
| cases | |
| Exception | If the location service is not enabled, this function cannot |
| conditions | be completed using location based properties |

Equally important, a service requester can set and search for a service provider rating 860. This may be a star rating or similar attributes that is designated by WTA user community. This reflects the ratings of prior users. As mentioned above, a service requester, upon selecting a service provider, can tab on the service provider's name in the list or icon on a map and read prior user reviews of the service provider. Reviews can range in all manners and ratings are averaged out between the multitude of reviews given by prior users. A service requester may also search manually 870 for a specific service provider and engage that specific service provider directly. In this case the service provider must have a registered account with WTA and must also be logged in. A status may be returned by WTA to a service requester if the service provider being searched for is registered but not logged in. If the service provider being searched for is not registered, then an error message will appear to the service provider indicating that the service provider does not exist. The service requester can search the service provider's name, user name, or any other identification credentials such as the service provider's phone number.

Alternatively, manual searching can be available for all users, including nonregistered users to enable trial of the system and allow users to view how a system may work if they were to take full advantage of its capabilities. Table IV below illustrates such manual searching capabilities.

TABLE IV
Manual Searching

| Use Case | Manual Searching | |
|---|---|---|
| Name | | |
| Actor | service requestor | |
| Goal | Allow the user (service requestor) to search for a | |
| | provider by his username | |
| Brief | The user can choose a driver by his username | |
| description | | |
| Pre- | The provider must have a registered account | |
| condition | | |
| Post- | | |
| condition | | |
| Flow of | | |
| Activity | | |
| for Actor | 1- | The user enter the requested driver's name in the |
| | | search field |
| for System | 1- | System has no need to check if the user is registered |
| | | or not, since this feature is available for non-registered |
| | | users as well |
| | 2- | If the entered name was found, the result will be |
| | | shown on another window |
| | 3- | If the result was not found, a notification will be |
| | | displayed to the user |

| | |
|---|---|
| Related Use | None |
| cases | |
| Exception | None |
| conditions | |

WTA allows users to enter multiple interaction platforms. For example, WTA enables users to interact via direct messages and sharing, setting favorites. For example, when a service provider wishes to discuss elements of a transaction with a service requester, or vice versa, either one can access this option by clicking the message icon in his/her profile or the other party's profile. The user can send messages to the other user only if the order is in progress and is not finished. Alternatively, one user can send another user messages if they have matching searching criteria, if one user has solicited services from the other or one party has been solicited by the other. WTA can check to see if the order is still in progress to enable the texting environment or not. An example of this is illustrated in Table V below.

TABLE V
Direct Message Interaction

| Use Case | Interaction - Direct Messages | |
|---|---|---|
| Name | | |
| Actor | Service requestor - service provider | |
| Goal | Allows any user to interact with another user using this | |
| | application | |
| Brief | Direct Messages provides a way for both parties | |
| description | (requester/provider) to communicate with each other during | |
| | the progress of the order and deactivate it after the order | |
| | is completed | |
| Pre- | 1- | User must be logged in |
| condition | 2- | There must be an order in the progress |
| Post- | This service is deactivated after an order for a service | |
| condition | is completed and the parties are no longer negotiating a | |
| | service. | |
| Flow of | | |
| Activity | | |
| for Actor | 1- | User can access this option by clicking the message |
| | | icon in his/her profile or the other party profile |
| | 2- | User can send messages to the party only if the order |
| | | is in the progress and not finished yet |

| | |
|---|---|
| for System | The system should check first if the order is in progress |
| | and both parties are involved in one order |
| Related Use | Ordering |
| cases | |
| Exception | None |
| conditions | |

In another example, WTA allows a user to share the user's experience with people outside WTA community. This gives the user the ability to share the progress of the user's order with others and what the user things about the provided service. In order to share, a user must be logged on and an order must be in progress. Thereafter, the user should have authorized account on the selected channel desired to use in sharing and the user's experience is shared through the user's social media account. An example of this can be further illustrated in table VI below.

TABLE VI
Interaction: Share

| Use Case | Interaction - Share | |
|---|---|---|
| Name | | |
| Actor | Service requestor - service provider | |
| Goal | Allows the user to share his experience with people outside | |
| | Wasul community | |
| Brief | Give the user the ability to share the progress of his/her | |
| description | order with others and what he/she think about the provided | |
| | service | |
| Pre- | 1- | The user must be logged in |
| condition | 2- | The user must has order on progress |
| | 3- | The user should have authorized account on the |
| | | selected channel he/she desired to use in sharing |
| Post- | None | |
| condition | | |
| Flow of | | |
| Activity | | |
| for Actor | 1- | The user presses sharing button next to the order |
| | | description |
| | 2- | The user chooses the desired sharing channel if none |
| | | was configured before |
| | 3- | The user clicks share button so the experience can |
| | | be shared with others |
| for System | 1- | The system should check for the pre-conditions first |
| | | and notify the user if one of them is not applicable |
| | 2- | After the user click share button, the system should |
| | | do its job and share the experience with others. |

| | |
|---|---|
| Related Use | None |
| cases | |
| Exception | None |
| conditions | |

Another interactive means allowed by WTA between service providers and service requesters is the option to tag a service provider as a favorite, or vice versa. This allows any user to follow another user of the first user's interest within WTA community. This can enable a user, such as a service provider; about users the service provider might be interested in their updates inside WTA community. For example, a service provider may be interested to know where or when a prior service requester is coming to town or may require a potential service and this enables a service provider to solicit a service request when learning information about the service requester when setting the service requester as a favorite. The following features can be reversed and blocked by the users. For example, a user can block another user from following the first user, or a user can be removed from the followed list. An example of this can be further illustrated in Table VII below.

TABLE VII
Interaction: Favorite

| Use Case | Interaction - Favorite | |
|---|---|---|
| Name | | |
| Actor | Service requestor - service provider | |
| Goal | Allowing the any user to follow another one of his | |
| | interest within Wasul community | |
| Brief | The user can be updated about other users he/she might | |
| description | be interested in their updates inside Wasul community | |
| Pre- | User must be logged in first | |
| condition | | |
| Post- | The effects of this function should take place in a | |
| condition | database and data displayed in the user profile | |
| Flow of | | |
| Activity | | |
| for Actor | User should click follow button that is provided in each | |
| | user profile | |
| for System | 1. | System should check if the user is logged in or not |
| | | and notify him to do so if not |
| | 2. | The system should reflect the effects after the user |
| | | clicks the follow button |

| | |
|---|---|
| Related Use | None |
| cases | |
| Exception | The user cannot follow a user he/she already follows, and |
| conditions | the user can unfollow another one by clicking unfollow |
| | button provided in the place of follow button |

Users are able to rate their experience by rating their experiences in dealing with each other. The users can rate each other after the order is complete for the service requester by the service provider. Rating results can be displayed on the profile of each involved participant including providers and requesters. The user will be shown a window to rate the other participant and the user should do it and click the rate button. Users also have the ability to recommend or not recommend one another. A service requester may recommend a service provider if the requester is satisfied with the performance. Recommendation can be to friends or other users of the WTA community. The effects of this function can take place in WTA's database and user profiles adding the recommendation activity to both users' activities and increment the number of recommenders in the provider's database. An example of this can be further illustrated in Tables VIII and IX below.

TABLE VIII
Evaluating - Rate

| Use Case | Evaluating - Rate | |
|---|---|---|
| Name | | |
| Actor | Service requestor - service provider | |
| Goal | Allowing users to rate their experience in dealing | |
| | with each other | |
| Brief | The users can rate each other after the order was | |
| description | done for the service requestor by the service provider | |
| Pre- | 1. | Users must be logged in |
| condition | 2. | Users must have order they are involved in |
| | 3. | Service provider must declare the completion of |
| | | the order by clicking (order done) and service |
| | | requester notified after that (might be automated) |
| Post- | Rating results should be displayed on the profile of | |
| condition | each involved participant | |
| Flow of | | |
| Activity | | |
| for Actor | User will be shown a window to rate the other | |
| | participant and he/she should do it and click rate | |
| | button | |
| for System | 1. | System should check for the pre-conditions first |
| | | to allow both parties to rate each other. |
| | 2. | The rating result will be saved and take effects |
| | | on the users profiles |

| | |
|---|---|
| Related Use | None |
| cases | |
| Exception | Users cannot escape rating each other, however, a user |
| conditions | can have the option to appeal a rating given by another |
| | user to the Wasul community such that a rating can later |
| | be modified or removed by the community. In this manner, |
| | and given that some users may rely on this application as |
| | a means to make a living, any ill advised rating by one |
| | user may be addressed by the community to lessen the |
| | severity of its affects assuming it was wrongfully |
| | assessed in the first place. |

TABLE IX
Evaluating - Recommendation

| | |
|---|---|
| Use Case | Evaluating - Recommendation |
| Name | |
| Actor | Service requestor/provider |
| Goal | Allows both parties to recommend each other |
| Brief | Users can recommend the other party to friends after the |
| description | order is completed and rating was done |
| Pre- | Rating process was done with its conditions |
| condition | |
| Post- | Effects of this function should take place in the system's |
| condition | database and users profile (adding the recommendation |
| | activity to both users activities and increment the number |
| | of recommenders in the providers database) |
| Flow of | |
| Activity | |
| for Actor | User has the choice to recommend the other party or not |
| | if he/she doesn't do before |
| for System | System asks both participants to recommend each other |
| | after rating process is completed, recommendation is |
| | optional, users can skip it if they like to do so |
| Related Use | Evaluating - rate |
| cases | |
| Exception | None |
| conditions | |

In one embodiment, a service requester may order a service by asking for a service from a service provider. In this case, both users must be logged in which allows the ordering transaction to be registered and monitored by both participants. A service requester can complete an order form of criteria as stated before and specify a service provider if one exists. The service requester can choose from one or more providers or leave the field empty and allow the system to look for a provider automatically. The service provider will be sent a notification of a type such as an email notification, an SMS notification or any other means of a notification to check if the service provider is interested in providing the service or not, and to decline the request if the provider is not. If the service provider does not answer within a specified predetermined time, for example, 15 minutes, the service requester will be notified and the system looks for another service provider to fulfil the request. Ordering can be done in a variety of ways. One way is further illustrated in Table X below. The example in Table X below is meant to be illustrative in nature of one of many embodiments and is not limiting to just the ordering options included in the Table.

TABLE X
Ordering Service

| Use Case | Ordering | |
|---|---|---|
| Name | | |
| Actor | Service requestor - service provider | |
| Goal | Allows the main function of this application which is | |
| | ordering a service from a service provider | |
| Brief | Service requestor can ask for a service provider through | |
| description | this function | |
| Pre- | Both users must be logged in | |
| condition | | |
| Post- | Ordering a service is registered and activity progress can | |
| condition | be monitored by both participants | |
| Flow of | | |
| Activity | | |
| for Actor | 1- | Service requestor should complete the form of order |
| | | and specify service provider if he/she willing to do |
| | | so- the requester can choose one or more providers- |
| | | or leave it empty so the system looks for one |
| | | automatically |
| | 2- | The service provider will be sent a notification + |
| | | email + SMS to check if he is interested in the order |
| | | or not, if he decline the order or hasn't answered |
| | | within a preallocated time slot, such as 1, 2, 5, 10 or |
| | | 15 minutes, the service requestor will be notified |
| | | and the system looks for the another driver he/she |
| | | chooses - or choose one automatically if the |
| | | requester doesn't choose one |
| for System | 1- | System must check for the pre-condition first |
| | 2- | The system should save the order form temporary so |
| | | the information can be used in looking for other |
| | | drivers if needs so. |
| | 3- | The system should look for drivers near the |
| | | requestor if he/she doesn't specify one or |
| | | the driver decline the order. |
| Related Use | None | |
| cases | | |
| Exception | None | |
| conditions | | |
| Use Case | Login | |
| Name | | |
| Actor | service requestor - service provider | |
| Goal | To allow the user to access his/her Wasul account and | |
| | start interacting with the system | |
| Brief | The user (requestor or provider) must have an account | |
| description | to access the system and start interacting with it | |
| Pre- | The user must have account | |
| condition | | |
| Post- | Login is done successfully | |
| condition | | |
| Flow of | | |
| Activity | | |
| for Actor | 1- | Enter username and password |
| | 2- | Click“login”button |
| | 3- | Start interacting with the system |
| for System | 1- | Display the log in page |
| | 2- | Check the validation of the username and the |
| | | password in the database |
| | 3- | Open the profile for the user if his/her user name |
| | | and password are correct |

| | |
|---|---|
| Related Use | Registration via Form and One-Click registration |
| cases | |
| Exception | If the user enters incorrect username of password |
| conditions | a- The system will display an error message for the user |
| | and ask him/her to enter them again until the valid |
| | information is accepted |
| | b- In case the user forget password, he/she has to click |
| | on“forget your password”link. Then enters his/her |
| | username and email. After that the system will send an |
| | email containing the password. |

WTA offers several advantages to users. WTA can create an additional source of income for service providers. WTA can operate on existing electronic platforms and can work as a guide for service providers and requesters. WTA can organize the work schedule for service providers. Providers can grow their business or advance their performance by the user of sharing and collecting of points given by service requesters and allows for a service provider to receive delivery requests for potential points of interest that are closest to the driver to enhance productivity, efficiency and reduce expenditure. WTA further advances the service provider/service requester interaction and facilitates transactions in a seamless and integrated manner.

WTA further uses technology that helps to ensure the time of arrival of shipping and the required quality, and it may be presented in a very easy and user friendly ways. WTA also includes authentication through the social nature of the application, such as, review of the service provider's picture, name, assessment and views of the service provider's previous clients, a number and type of recommendations, the number of services provide, the user's favorites, date of registration, the collateral owned by the driver and badges and certifications obtained to account for commitment of time, deals offered, vehicle comfort and price fairness.

In yet another embodiment, one of WTA's advantages is the inclusion of a contract formation during a registration process for users to accept the terms and privacy settings of WTA. This ensures that when users interact, their contract formations are guaranteed.

A user may be able to manage his or her profile on the Application. The user is allowed to modify the profile settings to enhance his or her experience by accessing the settings of their profile by clicking its assigned button and change the settings as needed. For example, the user can set his login status as service provider, service requester or both. Table XI illustrates one example of profile management.

TABLE XI
Managing Profile

| Use Case | Managing Profile | |
|---|---|---|
| Name | | |
| Actor | Service requestor - service provider | |
| Goal | Allows the user to modify the profile setting to enhance | |
| | his/her experience | |
| Brief | the user can access the settings of his profile by clicking | |
| description | its assigned button and change the setting he/she needs | |
| Pre- | the user must login first to his profile | |
| condition | | |
| Post- | the changes must take effect on the current session the | |
| condition | user is in | |
| Flow of | | |
| Activity | | |
| for Actor | 1. | The user choose managing profile by pressing its |
| | | assigned button |
| | 2. | The user changes the settings he/she wants after |
| | | the required page displayed for him/her |
| | 3. | The user clicks save after completing changes |
| for System | 1. | The system displays the setting page after the user |
| | | requests it |
| | 2. | The system must check if the changes are accepted |
| | | or not after the user clicks save button |
| | 3. | If the changes are accepted the system will close |
| | | the current page and changes will take effect on |
| | | the current session |
| | 4. | If the changes are not accepted by the system the |
| | | user will be notified to correct them |

| | |
|---|---|
| Related Use | None |
| cases | |
| Exception | None |
| conditions | |

In one embodiment, a system for peer to peer transport accommodation is disclosed that includes circuitry configured to detect a user's login status as a service provider, service requester, or both service provider and service requester and provide an interactive search menu based on the user login status. The system can then determine a location of one or more available service providers and service requesters, the location of each available service provider and service requester being based on data received from a user application executing on a corresponding mobile computing device associated with that user and receive a service request from a first user application executing on a mobile computing device of a first user, the service request including at least one service parameter solicited by the first user.

In yet another embodiment, the system may be further configured to display, in response to receiving the request from the first user, the interactive search menu having an available user that has advertised a capacity of performing the at least one parameter solicited by the first user, wherein the interactive search menu further includes a negotiation window configured to present, to the first user and to the available user, the ability to further negotiate the at least one parameter.

The interactive search menu and the negotiation menu may be considered two distinct display windows or in another embodiment, the negotiation menu can be a part of the interactive search menu. The interactive search menu can be configured to display available service providers for a service requester and alternatively, display available service requesters for a service provider. In either case, the interactive search menu can enable a service requester to search, identify, and select targeted service providers. Selecting a service provider may be performed by touch screen functionality or by an operative menu selection mechanism. A service provider, alternatively, may advertise services the service provider is willing to perform and any other parameters associated with the service. For example, a service provider may wish to advertise that he is willing to perform a transport service, that the transport service is for a person or a number of persons, and that the transport service includes a predetermined set of geographic locations. For example, a service provider may decide, on their way back home to advertise that he is travelling from time x to time y on rout z and willing to accept a given number of passengers for a given fair amount. Alternatively the service provider may advertise other services, including, for example, transporting commodities, such as goods, food delivery items, etc.

When the interactive search menu has enabled display of available service requesters and service providers and enabled solicitation of services or advertisement of services, the negotiation window may further enable parties to negotiate certain parameters and advance the transaction. Negotiations may include negotiations of price, size, time, duration, route, or any other parameters related to transport services.

This peer to peer transport accommodation system generates greater advantages to enable direct, informed, and expedited transport of goods and services between parties. For example, the interactive search menu helps identify service providers for service requesters. Alternatively, it also helps identify service requesters for service providers. Furthermore, it enables parties to identify and prioritize certain transport parameters and negotiate the parameters via a negotiation window. The parties are further able to rate each other, communicate and chat with each other during service performance.

The peer to peer transport accommodation system further allows users to schedule their tasks far in advance. For example, a service provider may seek to use this accommodation system as a means to make a living. In such cases, the service provider may need to seek to fill his work hours for a given future period of time in order to determine future income and services. As such, the service provider may have the option to connect with service requesters, and schedule their services within a predetermined scheduled time. For example, to avoid having to schedule a transportation service on the spot, a service requester may want to search for a service provider willing to perform the transportation service within a given time in the future, say for example, a week in advance (e.g. next Tuesday). The service requester has the ability to secure the service in advance while the service provider can also secure an income slot.

The tasking capabilities of the peer to peer transport accommodation allow a service provider to track scheduled services and also allows the service provider to track additional parameters, including generated income from the services, frequency of specific services and client meta data. Additionally, the service provider may use the task scheduler to set reminders of when services are to be performed. Alternatively, a service requester may also use the task scheduler to track all service requests the service requester has solicited.

1. A system for peer-to-peer (P2P) transport accommodation comprising:
circuitry configured to
detect a user's login status as a service provider, service requester or both service provider and service requester, and provide an interactive search menu based on the user login status,
determine a location of one or more available service providers and service requesters, the location of each available service provider and service requester being based on data received from a user application executing on a corresponding mobile computing device associated with that user,
receive a service request from a first user application executing on a mobile computing device of a first user, the service request including at least one service parameter solicited by the first user, and
display, in response to receiving the request from the first user, the interactive search menu having an available user that has advertised a capacity of performing the at least one parameter solicited by the first user, wherein the interactive search menu further includes a negotiation window configured to present, to the first user and to the available user, the ability to further negotiate the at least one parameter.

2. The system of claim 1, wherein the user's login status is a service requester.

3. The system of claim 2, wherein the interactive search menu is further configured to display different control parameters based on the user's login status.

4. The system of claim 1, wherein the interactive search menu provides an option to set at least one service request parameter related to a transport service request.

5. The system of claim 4, wherein the at least one service request parameter includes at least one of a geographic location parameter, a pick up time parameter, a drop off time parameter, a service provider rating parameter, a service vehicle information parameter, a traveled route parameter, a package size parameter, and an estimated cost parameter.

6. The system of claim 5, wherein in response to receiving the service request with at least one service request parameter from the service requester, the circuitry is further configured to display at least one available user that has logged in as a service provider, and to transmit the service request to the service provider.

7. The system of claim 6, wherein the transmitted service request includes an option to accept, reject or counter offer the service request and in response to receiving a response from the service provider, the circuitry is further configured to transmit the service provider response to the service requester and display the service provider response in the negotiation window.

8. The system of claim 1, wherein the user's login status is a service provider.

9. The system of claim 8, wherein upon detecting the user's login status as a service provider, the circuitry is further configured to provide an interactive search menu configured to display interactive parameters for advertising a set of services offered by the service provider and interactive parameters for soliciting requests for a service from at least one user logged in as a service requester.

10. The system of claim 1, wherein the user's login status is both, a service requester and as a service provider.

11. The system of claim 10, wherein the circuitry is further configured to allow the user to simultaneously communicate with service providers as a service requester and communicate with service requesters as a service provider.

12. The system of claim 1, wherein the circuitry is further configured to generate a task schedule for a given period of time for all tasks accepted by the user.

13. The system of claim 12, wherein the circuitry is further configured to generate at least one reminder for each accepted task by the user.

14. A method to facilitate peer-to-peer (P2P) transport accommodation comprising:
detecting a user's login status as a service provider, service requester or both service provider and service requester;
providing an interactive search menu based on the user login status;
determining a location of one or more available service providers and service requesters, the location of each available service provider and service requester being based on data received from a user application executing on a corresponding mobile computing device associated with that user;
receiving a service request from a first user application executing on a mobile computing device of a first user, the service request including at least one service parameter solicited by the first user; and
displaying, in response to receiving the request from the first user, the interactive search menu having an available user that has advertised a capacity of performing the at least one parameter solicited by the first user, wherein the interactive search menu further includes a negotiation window configured to present, to the first user and to the available user, the ability to further negotiate the at least one parameter.

15. The method of claim 14, wherein the interactive search menu provides an option to set at least one service request parameter related to a transport service request.

16. The method of claim 15, wherein in response to receiving the service request with at least one service request parameter from the service requester, the method further comprising
displaying at least one available user that has logged in as a service provider, and to transmit the service request to the service provider.

17. The method of claim 16, wherein the transmitted service request includes an option to accept, reject or counter offer the service request and in response to receiving a response from the service provider, the method further comprising
transmitting the service provider response to the service requester and displaying the service provider response in the negotiation window.

18. A non-transitory computer-readable medium having computer-readable instructions thereon which when executed by a computer cause the computer to perform a method for captioning media, the method comprising:
detecting a user's login status as a service provider, service requester or both service provider and service requester;
providing an interactive search menu based on the user login status;
determining a location of one or more available service providers and service requesters, the location of each available service provider and service requester being based on data received from a user application executing on a corresponding mobile computing device associated with that user;
receiving a service request from a first user application executing on a mobile computing device of a first user, the service request including at least one service parameter solicited by the first user; and
displaying, in response to receiving the request from the first user, the interactive search menu having an available user that has advertised a capacity of performing the at least one parameter solicited by the first user, wherein the interactive search menu further includes a negotiation window configured to present, to the first user and to the available user, the ability to further negotiate the at least one parameter.

19. The non-transitory computer-readable medium of claim 18, wherein in response to receiving the service request with at least one service request parameter from the service requester, the method further comprising
displaying at least one available user that has logged in as a service provider, and to transmit the service request to the service provider.

20. The non-transitory computer-readable medium of claim 19, wherein the transmitted service request includes an option to accept, reject or counter offer the service request and in response to receiving a response from the service provider, the method further comprising
transmitting the service provider response to the service requester and displaying the service provider response in the negotiation window.
